(19) United States
(12) Patent Application Publication
(10) Pub. No.: US 2003/0065524 A1
(43) Pub. Date: Apr. 3, 2003

(54) Virtual beauty consultant

(76) Inventors: Daniela Giacchetti, Paris (FR); Gilles Rubinstenn, Paris (FR); Francis Pruche, Senlis (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,620

(22) Filed: Dec. 21, 2001

Related U.S. Application Data
(60) Provisional application No. 60/325,559, filed on Oct. 1, 2001.

(51) Int. Cl. G06F 17/60

(52) U.S. Cl. 705/1

(57) ABSTRACT

Systems, methods, and apparatus consistent with the present invention may be used to provide subjects with electronic beauty analyses. Beauty information may be maintained in a data structure. A subject may initiate an analysis through an interface coupled to the data structure. A virtual consultant may visually and/or audibly present queries to the subject via the interface. Responses to the queries may be retrieved, and information reflective of the responses may be incorporated into subsequent queries. The present invention may involve providing beauty guidance to the subject, via the virtual consultant, based on the responses to queries.

### BACKGROUND OF THE INVENTION

1. Field of the Invention

The present invention generally relates to interactive computer systems, and more specifically to systems, methods, and apparatus for providing interactive beauty guidance. In one example, the present invention may provide customized beauty advice by way of a virtual beauty consultant.

2. Description of Related Art

The process of choosing appropriate beauty products may involve the weighing of various criteria including one or more of the customer's physical attributes, age, lifestyle, apparel and color preferences, and make-up preferences. Thus, beauty product purchasing decisions are often facilitated through interactions with beauty consultants. Indeed, many retail stores have departments dedicated to the sale of beauty products. Those departments are often staffed by personnel with experience in the selection and application of beauty products. Many customers enjoy the personal attention available through the department store experience. Similarly, beauty facilities and specialty stores make a brisk business of dispensing beauty product advice in a personalized manner.

More recently, companies selling cosmetics have attempted to automate the cosmetic purchasing process using website portals. As the advent of the Internet has shown, many consumers value the convenience and privacy provided by electronic commerce. Consumers appreciate the ability to bypass the traditional constraints of store hours, travel time, and appointments. This may be accomplished with on-line catalogs, product searches, and other tools which allow consumers to search for, explore and purchase products in an electronic environment. However, the typical internet sales model may not be best suited for the sale of beauty products.

A typical on-line purchasing experience involves self-selection of beauty products, and “placing” the selected product in a virtual shopping cart. Even when web sites attempt to provide tools to aid in the beauty product selection process, the experience often remains cold and sterile, lacking the personal attention that makes the in-store purchasing experience pleasurable for so many beauty product customers.

From the customer's perspective, the inability of electronic commerce to provide a more personal experience may discourage on-line shopping. From the cosmetic provider's perspective, this may translate into sales volumes lower than would otherwise be achieved with a more personal approach.

Thus, for certain categories of products, such as cosmetics, there may be a need for an interface with a more personalized look and feel. Current technologies often lack the ability to effectively provide consumers with certain consultative services, such as a sense of a personalized beauty analysis. Indeed, existing technologies and services are often impersonal and lack solicitousness, therefore causing them to be ineffective substitutes for live human interaction.

### SUMMARY OF A FEW ASPECTS OF THE INVENTION

One aspect of the invention may involve a beauty analysis method. In one respect, the invention may involve providing guidance in response to received subject-characterizing information. Such information characterizing the subject may be obtained from the subject (or someone acting on the subject's behalf) through a series of queries.

In exemplary embodiments, the queries and guidance information may be maintained in a data structure. Methods may be provided for establishing an interface with a subject for enabling the subject to participate in an interactive beauty analysis. Methods may also be provided for visually and/or audibly presenting a virtual beauty consultant to the subject. In one embodiment, a human image may be presented via a display device. The present invention may involve causing the virtual consultant to present queries to the subject. Responses to the queries may be received, and information reflective of the responses may be incorporated into subsequent queries. The present invention may involve providing beauty guidance to the subject, via the virtual beauty consultant, based on the responses to queries.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing and the following descriptions are exemplary and explanatory only and are not intended to limit or define the claimed invention in any manner whatsoever.

### BRIEF DESCRIPTION OF THE DRAWINGS

The accompanying drawings, which are incorporated in and constitute a part of this specification exemplify the invention and together with the description, serve to explain the principles of the invention.

FIG. 1 depicts an exemplary screen shot consistent with the present invention;

FIG. 2 depicts another exemplary screen shot consistent with the present invention;

FIG. 3 is a flowchart consistent with methods of the present invention;

FIG. 4 is a screen shot of a virtual consultant selection system consistent with an alternative embodiment of the invention;

FIG. 5 is an exemplary block diagram of a system in which the present invention may be practiced;

FIG. 6 is a detailed block diagram representative of a server system depicted in the system of FIG. 5;

FIG. 7 is a detailed block diagram representative of a user access system depicted in the system of FIG. 5; and

FIG. 8 is a detailed flow chart depicting the operation of an embodiment of the present invention.

### DESCRIPTION OF EXEMPLARY EMBODIMENTS

In the following description of exemplary embodiments, reference will be made to the accompanying drawings in which like numerals represent the same or like elements.

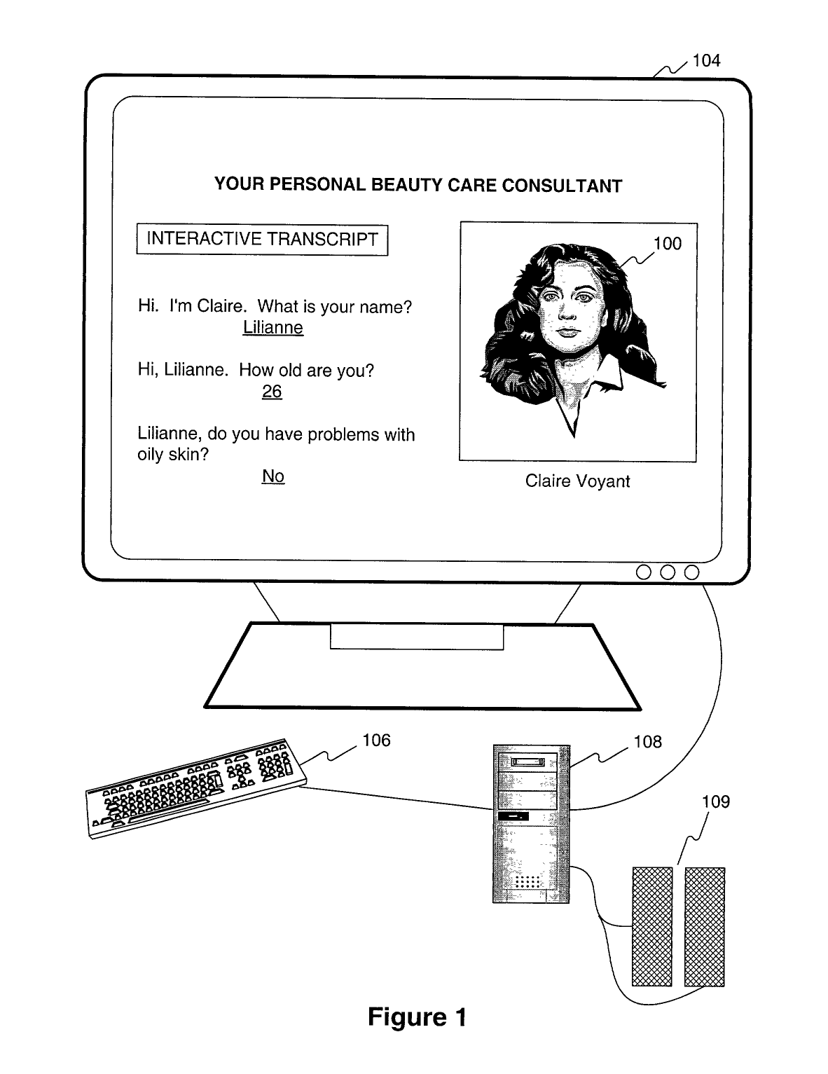

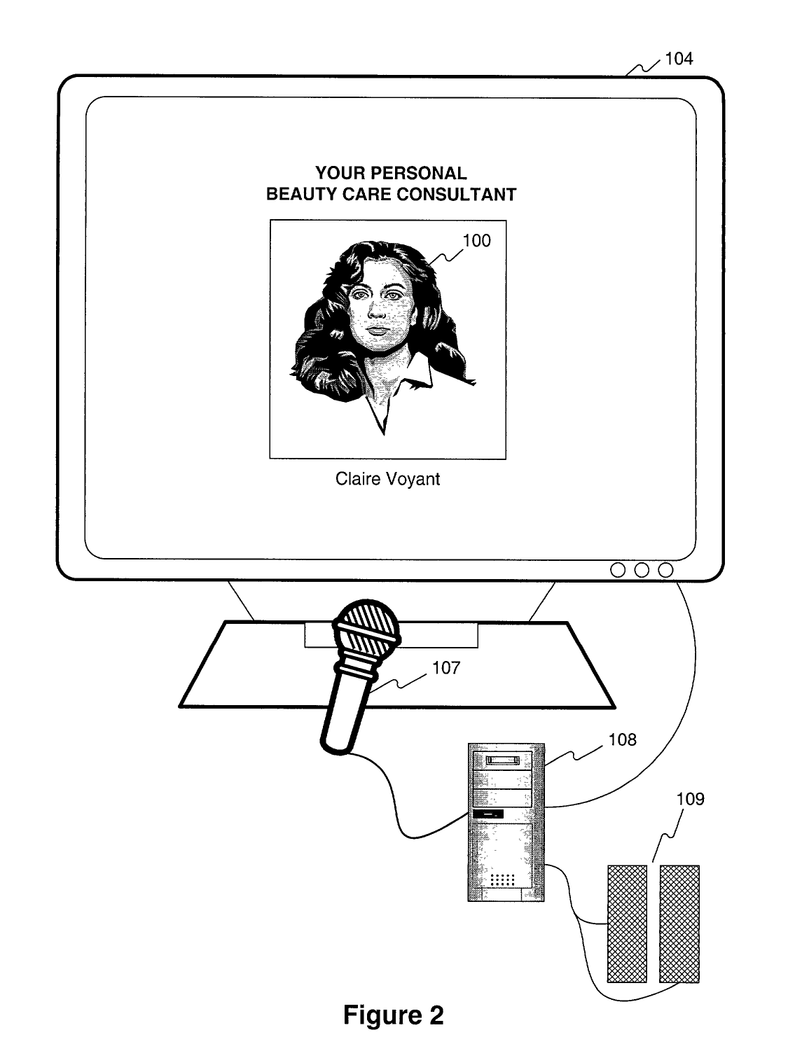

One exemplary embodiment of the present invention may provide a user with personalized on-line beauty guidance through the use of a “virtual beauty consultant.” Exemplary configurations are depicted in FIGS. 1 and 2. As illustrated in FIG. 1, virtual beauty consultant 100 may interact with a user or “subject”. In one embodiment, this interaction is facilitated by way of the subject inputting information via keyboard 106 and the virtual beauty consultant outputting information via display device 104 and speakers 109. FIG. 2 is similar to FIG. 1, with the user audibly supplying input via microphone 107. Both of these exemplary embodiments provide a more personalized interaction with a subject than conventional beauty care systems. As opposed to impersonal questionnaires or the like, the present invention may provide guidance to a subject through a human-like interface, thereby creating a personalized experience.

The foregoing discussion is intended to introduce and clarify some of the aspects associated with present invention by way of the exemplary embodiments depicted in FIG. 1 and FIG. 2. Further details of these embodiments as well as additional aspects and embodiments of the present invention will be described in the following discussion. However, it is to be understood that other alternative embodiments may be utilized and that structural and method changes may be made without departing from the scope of present invention. The foregoing and following discussion are, therefore, not to be construed in a limiting sense.

One aspect of the invention may involve a beauty analysis method. As used herein, “analysis” and “guidance” are used interchangeably to refer to any situation where information is provided to a subject.

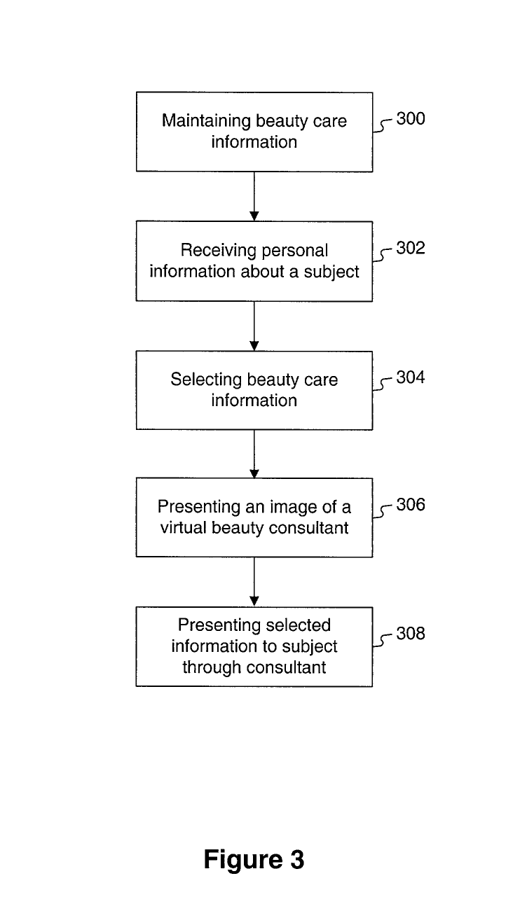

Consistent with an exemplary embodiment of the present invention, there may be provided methods for maintaining beauty information in a data structure, as indicated in step 300 of FIG. 3. As used herein, beauty information may include, but is not limited to, one or more of beauty related queries and beauty guidance. By way of a non-limiting example, queries may seek information on personal attributes such as hair color, hair density, hair thickness, hair condition, length, and style; skin tone, color, blemishes, wrinkles, freckles, texture, or lines, and elasticity; size and proportion of facial features; eye color; presence of beauty marks; height, weight and age. Queries may also seek lifestyle information such as vocation, color preferences, clothing style preferences, geographic location, travel habits, sun exposure habits, eating habits, and fitness information. Queries may further seek medical history, family history, and beauty information such as adverse reactions to products or compounds, reactions to the elements (e.g., sun exposure) physical characteristics and trends in relatives (e.g., premature balding, wrinkles, etc.) use of prior beauty products and their effectiveness, and physical fitness. In essence, the queries may be designed to elicit any personal information that aids in providing beauty guidance.

As mentioned above, the maintained beauty information may also include beauty advice or guidance. This information may be in the form of product recommendations, product usage information, preventative measures, remedial measures, lifestyle or dietary recommendations or any advice or guidance that might correlate to a subject. Accordingly, the above-mentioned queries may elicit information is known to correlate to specific beauty guidance. This “knowledge” may be based on scientific studies, questionnaires, surveys, empirical data, or through the experiences of experts or others individuals involved in the beauty and health industries.

Consistent with exemplary embodiments of the present invention, methods may be provided for receiving personal information about a subject, as indicated in step 302 of FIG. 3. Personal information may include, but is not limited to, physical characteristics, lifestyle, past beauty treatments, or any other information related to a subject such as the topics discussed previously with respect to beauty information. In one embodiment, personal information may be responses to the above-mentioned queries. Personal information may also include information electronically gleaned by tracking the subject's electronic browsing or purchasing habits, or as the result of cookies maintained on the subject's computer, responses to surveys, or any other mechanism providing information related to the subject.

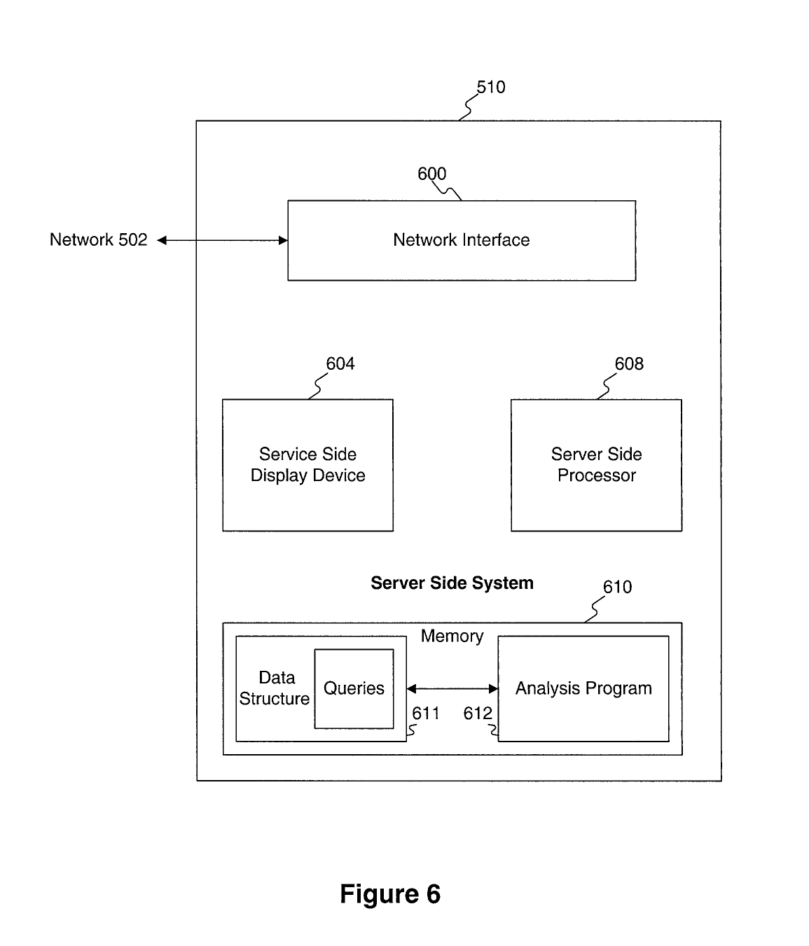

Personal information may be communicated through keyboard 106 or microphone 107, as illustrated in FIGS. 1 and 2, respectively. However, personal information may also be received from any type of interface, such as a mobile phone, PDA, kiosk, in-store display, or any mechanism, regardless of structure or location, for enabling network communication. Details of one example are described later in connection with FIG. 6.

Consistent with exemplary embodiments of the present invention, methods may be provided for selecting for presentation to a subject at least some of the maintained beauty information based on the received personal information. This is graphically depicted in step 304 of FIG. 3. This step may involve employing an analysis program. While the invention, in its broadest sense, is not limited to any particular analysis program or functionality thereof, it may include one or more of a querying selection mechanism and a guidance selection mechanism.

The querying selection mechanism may be configured to select from a universe of stored queries, a subset of queries to be presented to a user. A decision tree, neural network, or any other logic based or artificial intelligence algorithm may be employed to select the appropriate queries for presentation. The selection of each query or series of queries may be based, at least in part, on a user's response to one or more previous queries. For example, if a user identifies herself as having excessive wrinkles and dry skin, follow-on queries about wrinkles might be presented to the user while queries probing the sources of oily skin might be suppressed. Consistent with principles of the present invention, responses to queries may be stored and incorporated in, or used to retrieve, subsequent queries. For example, a user may be asked for his or her name. Upon receiving a name, for instance Lilianne, subsequent queries may address the user as Lilianne. It should be appreciated that techniques for implementing such selection mechanisms are within the ordinary skill in the art.

A guidance mechanism may provide to users beauty guidance based on the subject's personal information. Thus, if input is received indicating a lack of skin moisture, the selected guidance may revolve around moisturizing techniques and/or products. As with the query selection mechanisms, the guidance mechanism might also rely upon an artificial intelligence engine, decision tree or any other type of logic-based program.

Consistent with exemplary embodiments of the present invention, methods may be provided for presenting to a subject an image of a virtual beauty consultant. This is indicated in step 306 of FIG. 3. As used herein, “virtual beauty consultant” may include any likeness with which a subject may interact. For example, the virtual beauty consultant may be an image of a woman as illustrated in FIGS. 1 and 2. The image may be a prerecorded image of an actual human-being or, alternatively, a synthesized human image. However, the “consultant” may take one or more alternative forms. The virtual consultant may be an image of someone identified as an expert, or may be presented as a girlfriend or confidant. Alternatively, the consultant might have an appearance customizable by the user, and might appear in any virtual environment. In an even broader sense, the consultant's image may be of a non-human life form. For example, a subject may be able to have a dog, cat, other animal, alien, or cartoon character be the consultant.

A consultant's image might appear as two- or three-dimensional images. The image might be of the consultant's entire body or a portion thereof, such as the head and shoulders illustrated in FIGS. 1 and 2. The image might always appear on the screen, or might appear only when the user has a need for assistance.

A plurality of differing consultant images might be stored and displayed depending on the personal characteristics of the user. Thus, if the user is a middle-aged career oriented individual, the image presented may share one or more of those characteristics so that the user might better identify with the virtual consultant. Alternatively, a more youthful or trendy virtual consultant may be employed to provide guidance to teenagers. The image presented may be a function of the user's response to preliminary questions or might be surmised through automated analysis of the user's online purchasing or browsing habits.

As with the virtual consultant's appearance, the environment might be customizable. So, for example, a customer might choose to receive beauty advice on the beach, at the kitchen table, in a spa, in an office setting, or in any one of a number of options provided to the user. The user might be able to mix and match customized environments and virtual consultants, enabling usual and unusual combinations to fit the personal preferences of the user. So for example, one user might choose to receive advice from a middle-aged woman in a spa, while another might prefer to receive advice from an alien at the kitchen table.

Once the user is “introduced” to a consultant, the same virtual consultant may appear every time the user revisits the site. This may be accomplished through an initial registration process and password assignment, or through other mechanisms such as placing a cookie on the user's hard drive. If the user has “personality issues” with the virtual consultant, the subject might be offered the ability to choose a new consultant. In addition, if the subject wants a second opinion from a consultant having a different style, the subject may be afforded the opportunity to seek alternative advice.

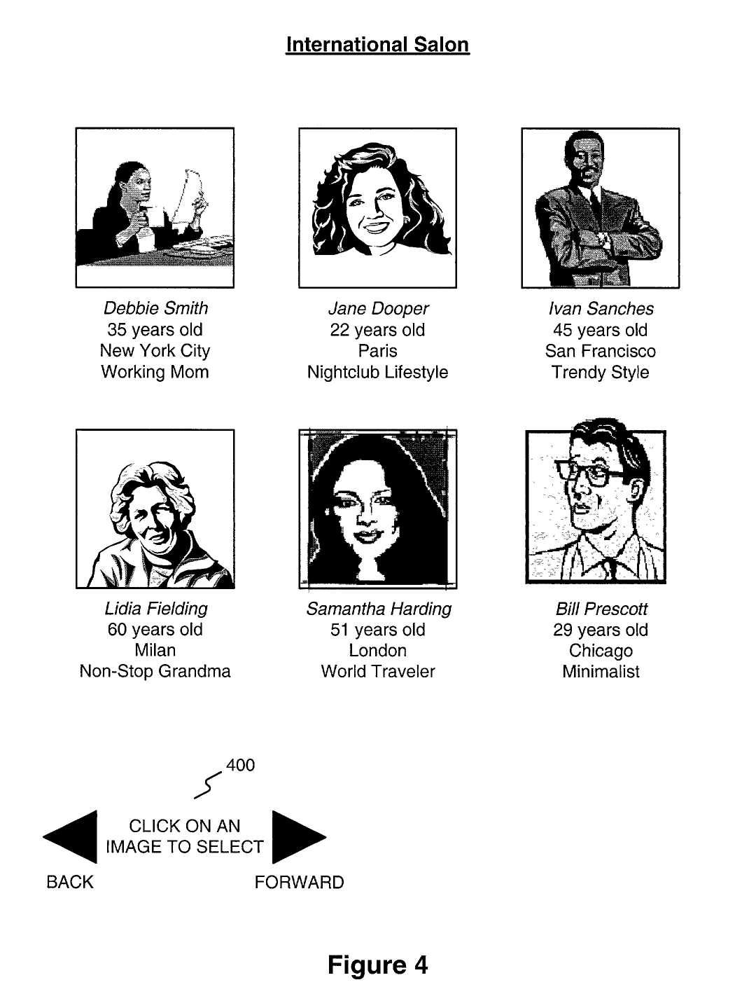

As an alternative to automatic matches of a consultant with a subject, the subject may be permitted to self-select a virtual consultant by viewing images and profile information on a number of differing consultants. A representative screen shot appears in FIG. 4. As illustrated, the subject might navigate using control buttons 400, and make a selection by clicking on an image of choice. In other embodiments, as suggested earlier, subjects may be able to select or create nonhuman entities for consultants.

In accordance with principles of the present invention, methods may be provided for causing the virtual beauty consultant to present to the subject the beauty information selected for presentation. This is indicated in step 308 of FIG. 3. Presenting may involve audio, video, or a combination thereof. In one embodiment, the consultant may be caused to emulate an actual human-being, and may present information to the subject in a manner consistent with a live human-being. Alternatively or in combination therewith, the presentation of guidance may occur in written form, either physically or electronically. During presenting, a full or partial body image of the consultant may be displayed. Likewise, in an alternate embodiment (not shown) a full or partial representation of the receiver of the beauty advice might also be displayed interacting with the virtual consultant. The character might be one chosen by the user and might even be a personification of the user. Such a personification may be two- or three-dimensional, and may be based on an electronically captured image of the user. In any embodiment, one or more of the virtual consultant or displayed receiver of the beauty advice might be displayed associated with a cartoon-like text bubble presenting text of an interaction.

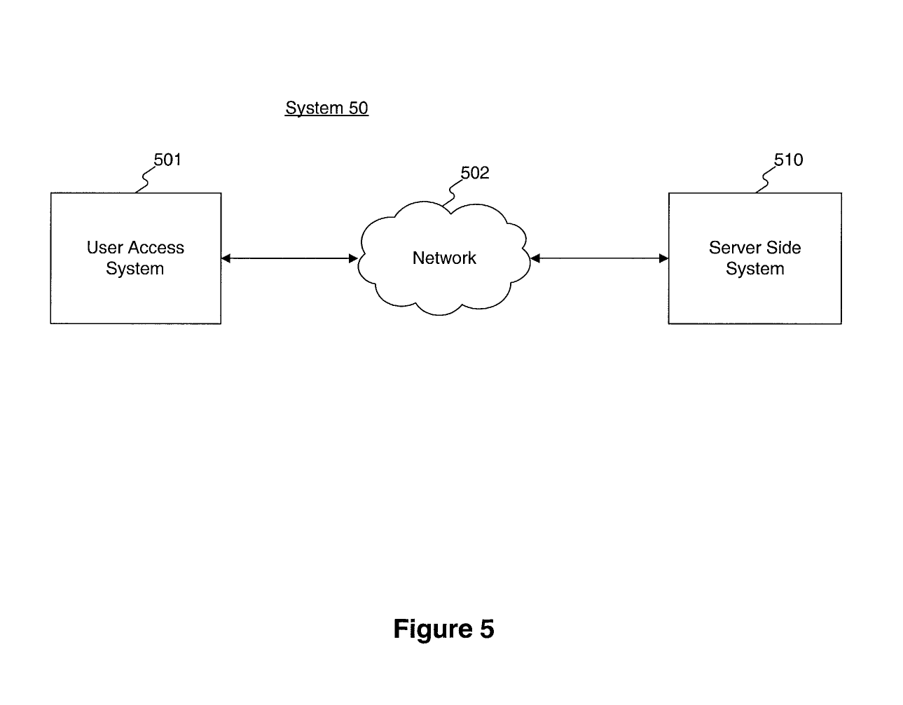

Beauty methods consistent with principles of the present invention may, in exemplary embodiments, be practiced in system 50 of FIG. 5. System 50 may include user access system 501 coupled, via network 502, to server side system 510. User access system 501 may include, but is not limited to, a personal computer, mobile computing device (e.g., a PDA), mobile communications device (e.g., a cell phone), a dedicated device programmed for a special purpose (such as a device that does not need to be booted and that might be located in a bathroom) or any other structure that enables a user to remotely access information.

For the sake of brevity, FIG. 5 illustrates a single user access system coupled to a single server system. However, one skilled in the art will realize that system 50 may comprise any number of geographically dispersed user access systems coupled to a server system. Similarly, in alternative embodiment, the user access systems may be coupled to a collaborative network of central processors or server computers.

Network 502 may include a public network such as the Internet, a private network, a virtual private network or any other mechanism for enabling communication between two or more nodes or locations. The network may include one or more of wired and wireless connections. User access system 501 and server system 510 may be, in an exemplary embodiment, operatively connected to network 502 by communication devices and software known in the art, such as are commonly employed by Internet service providers or as part of an Internet gateway.

As mentioned above, beauty information may be stored in a data structure. In one embodiment, a data structure may be contained in a computer's memory such as data structure 611 in memory 610 of FIG. 6. As used herein, “memory” broadly includes any device or mechanism for storing information. Example may include RAM, ROM, magnetic and optical storage media, audio disks, video disks, organic storage media, and any other information storage mechanisms. Data structure 611 may include, but is not limited to, a linked list and a stack.

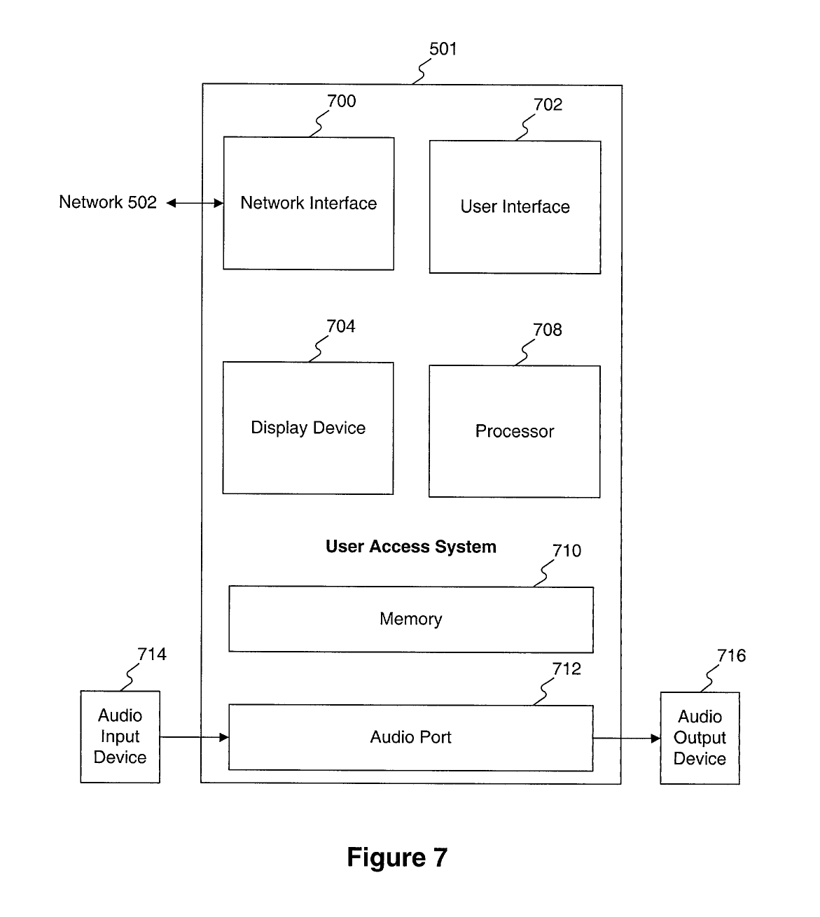

As illustrated in FIG. 6, server side system 510 may also include one or more of network interface 600, display device 604, and processor 608. Server system 510 may be connected to network 502 via network interface 600, which may be operatively connected via a wired or wireless communications link. Network interface 600 may be a network interface card, unit, or any other type of dedicated network connection. In operation, network interface 600 may be used to send data to and receive data from user access system 501 of FIG. 7.

Processor 608 may be operatively configured to receive input commands and data from a user associated with the user side of the network. Processor 608 may also be adapted to process commands received from analysis program 612. As illustrated in FIG. 6, analysis program 612 may reside in memory 610. However, in alternative embodiments, analysis program 612 may be stored/accessed from another location. Analysis program 612 may be used to manage, select, and present the stored beauty information.

Methods consistent with the present invention may also include establishing an interface with a subject for enabling the subject to obtain interactive beauty guidance. In one sense, this may be accomplished by providing hardware for use by the subject. In a broader sense, this may simply involve providing software either physically or for access over a network, for causing information to be presented to the subject. In yet another sense, establishing an interface may include making available a web site (either directly or indirectly) through which a subject may access the virtual beauty consultant.

User access system 501 may be defined by structures found in personal computers, hand-held devices such as personal digital assistants (PDA's), cell phones, or any other device capable of accessing data structure 611. In alternative embodiments, user access system 501 may be a kiosk which is coupled to a central computer having components similar to server system 510. For example, a beauty salon could have several kiosks linked to a central computer for customer use. In other embodiments, user access system 501 may simply be a “dumb” terminal or any structure for communicating over a network.

FIG. 7 illustrates one exemplary embodiment of user access system 501. Consistent with this embodiment, access system 501 may include one or more components (similar to those discussed previously with regard to server system 510) including network interface 700 for communicating with network 502; processor 708; and memory 710. Additionally, user access system 501 may include user interface 702. User interface 702 may include components such as keyboard 106 depicted in FIG. 1. However, user interface 702 may also be an input port connected by a wired, optical, or a wireless connection for electromagnetic transmissions. Alternatively, user interface 702 may be transferable storage media, such as floppy disks, magnetic tapes, compact disks, or other storage media for containing the input data from the user.

User interface 702 may include at least one button actuated by the user to input commands and thereby select from a plurality of processor operating modes. In other embodiments, user interface 702 may include, a mouse, a touch screen, and/or a data reading device such as a disk drive for receiving the input data from input data files stored in storage media such as a floppy disk or other storage tape. User interface 702 may alternatively include connections to other computer systems to receive the input commands and data therefrom.

Display device 704 may output text and/or images by way of a cathode ray tube, liquid crystal, light-emitting diode, gas plasma, or any other type display surface. Display device 704 may be, in one embodiment, computer monitor 104 illustrated in FIGS. 1 and 2. User access system 501 may also include audio port 712 coupled to audio input device 714 (e.g., microphone 107) and an audio output device 716, such as a speaker 109. For clarity, FIG. 7 illustrates audio input device 714 and audio output device 716 external to user access system 501; however, either or both of these devices may reside internal to the system.

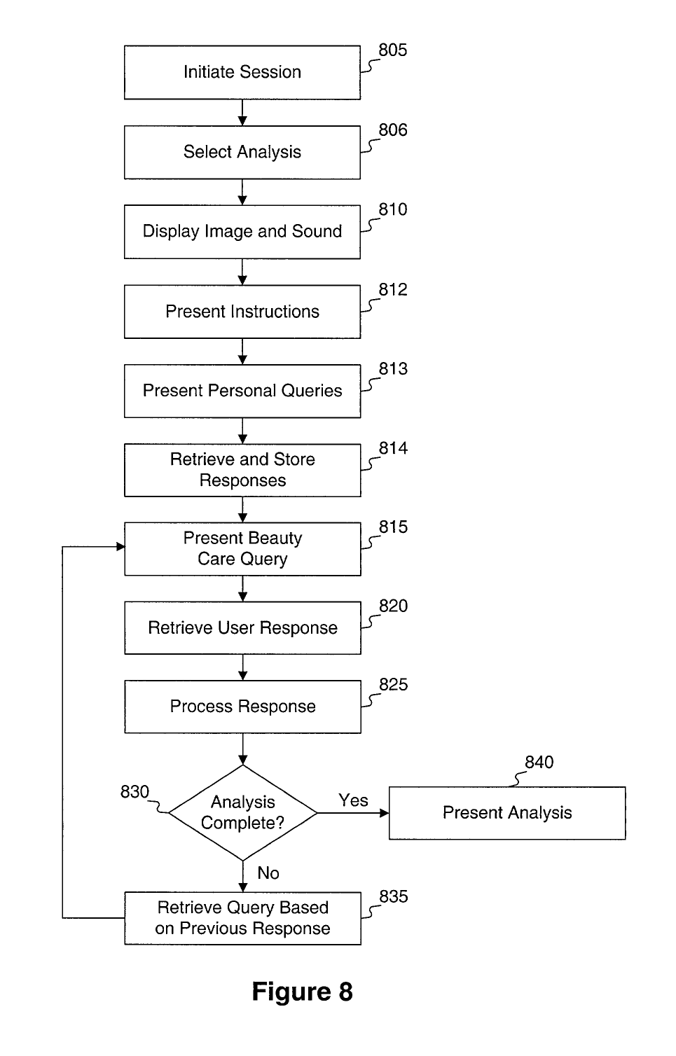

In operation, an exemplary embodiment of the present invention may function in accordance with the steps illustrated in flowchart of FIG. 8. However, it should be understood that other methods may be used to implement the invention, and even with the method disclosed in FIG. 8, the particular order of events may vary without departing from the scope of the present invention. Further, certain steps may not be present and additional steps may be added without departing from the scope and spirit of the claimed invention.

As illustrated in step 805 of FIG. 8, a communication session may be initiated by a subject. In one embodiment, this step may involve user access system 501 establishing a network connection with server system 510, via network 502, thereby enabling user access system to access data structure 611 and communicate with analysis program 612. In another embodiment, this step may involve a customer logging in at a kiosk or through a mobile device. In yet another example, step 805 may involve simply initiating previously installed or downloaded software.

Upon establishing a session, a user may be able to select a specific type of analysis or guidance, as illustrated by step 806. Accordingly, mediums may be provided to focus the virtual consultant on the type of guidance sought. Options might include an initial pick list of questions such as:

I need help picking a lipstick, mascara, blush, foundation, lip liner, eye liner, moisturizer, etc.

I need help with make-up for a formal event.

I need help with make-up for a casual event.

Voice recognition may be also used to initially direct the virtual consultant. The voice recognition feature may be in lieu of or in addition to a pick list of topics.

Once a session is established and the guidance type is chosen, analysis program 612 may cause an image of the virtual beauty consultant and corresponding audio to be presented to the user via display device 704 and audio output device 716 (FIG. 7). This may involve causing synthesized voice signals or pre-recorded human voice signals to be audibly projected through audio output device 716. This may also involve causing a synthesized or pre-recorded human image to be projected to the user via display device 704. In one embodiment, analysis program 612 may be responsible for handling the above-mentioned audio and video via processor 708. However, in an alternative embodiment, dedicated software may reside on user terminal 501 for processing audio and video. Consistent with an embodiment, user instructions may be stored in a data structure for gleaning sufficient information from the subject to provide guidance. As indicated in step 812 of FIG. 8, these instructions may be retrieved from the data structure and presented to a user through the above-mentioned virtual consultant by way of analysis program 612.

Analysis program 612 may, in one embodiment, cause a series of personal information queries, stored in data structure 611, to be presented on display device 704 of user access system 501, as indicated in step 813. As illustrated in FIG. 1, human image 100 may present information audibly through speaker 109, while a transcript of the presentation appears on display device 104. The user may then be prompted to respond using a user interface such as keyboard 106. A user may respond, for example, by checking a box or typing in a field. Alternatively, and as illustrated in FIG. 2, responses may be provided audibly through an audio input device such as microphone 107. For example, a query may inquire as to a user's name; and in response, the user may be able to speak the name into microphone 107. Voice recognition software provided on the user side, server side, or at some other location in the network may interpret the user's responses. The responses to these queries may be retrieved and stored in memory 710 for later use, as indicated in step 814.

As step 815 indicates, analysis program 612 may retrieve a beauty query from data structure 611 and cause the query to be presented to the subject. In one embodiment, this may involve audibly and visually presenting the query as described above. The virtual consultant may be caused to ask a question in a manner consistent with a live human being. Information reflective of the responses to the personal information queries (step 813) may be retrieved from memory and incorporated into the beauty query. For example, a user may be addressed by his or her previously inputted name. Analysis program 612 may remain in an idle state until the user responds to the query (step 820) or until a pre-determined time limit expires.

A user may select an answer from a group of answers presented by the analysis program 612. For example, in a skin treatment analysis, a query may ask the user to identify her skin type. Accordingly, a selection of responses (e.g. dry, oily, sensitive, normal, wrinkles) may be presented. A user may make a selection as described above, by checking a box, typing in a field, or speaking the answer. However, in another embodiment, a user may be able to type or speak a longer answer that is not presented as a choice, and analysis program may parse through and analyze the response. In one embodiment, after a user responds, program 612 may categorize and store the information in memory 710 (step 825).

Analysis program 612 may determine if enough information has been obtained from the user to provide the desired guidance, as indicated in step 830. This step may involve simply comparing the number of queries asked with the preset number of queries contained in a current series of queries. Alternatively, this step may involve comparing the received answer(s) with preset profiles. For example, analysis program 612 may contain profiles associated with various skin conditions, including various attributes or elements reflective of the conditions. In one embodiment, analysis program may determine if the information obtained from a user matches a particular profile. If, at step 830, it is determined that more information is required from the user in order to provide guidance, analysis program 612 may retrieve another query (step 835). This step may involve using the answer(s) to previous questions to obtain an appropriate query. For example, if a user indicates that she has wrinkles in a particular response, the next question might inquire as to where the wrinkles are located. This step may also involve incorporating responses to previous personal information queries into the query.

Once enough information is obtained from a subject, analysis program 612 may provide the analysis, as indicated by step 840. This step may involve retrieving and presenting preset information corresponding to the type of guidance sought by the subject. In an alternative embodiment, step 840 may involve comparing the stored answer(s) with pre-determined profiles to provide an appropriate analysis. For example, when a user's answers sufficiently match a specific profile, corresponding information may be retrieved and presented to the user. Analysis program 612 may employ mathematical algorithms to determine profile-answer matches. The responsive analysis information provided to the user may include the beauty information previously described. This information may be retrieved from memory and presented audibly and/or visually.

In yet another alternative embodiment, guidance might be provided through an actual consultant remotely located in front of a web camera. The actual consultant might follow a script, might be presented with questions by the processor, or might work in a free-style mode.

Moreover, some or all of the embodiments may further involve capturing an image of the subject, and using information gleaned from the image to further enhance the guidance provided to the user. Examples of systems and methods for capturing images are contained in concurrently filed applications incorporated herein by reference.

It should be understood that processes described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

It will be apparent to those skilled in the art that various modifications and variations can be made in the systems, methods and apparatus of the present invention and in the construction of this invention without departing from the scope of or spirit of the invention. For example, the foregoing assumes that queries and analysis software are stored in memory 610 of server system 510 and that users may participate in beauty analyses through terminals coupled to server system 510 via network 502. However, it should be understood that in other embodiments this system configuration may change. For instance, queries and associated analysis software may be downloaded from a network or uploaded from a computer readable medium and stored in memory of a user terminal; thereby altering or even eliminating the role of server system 510. In one example, a cosmetic company may provide its customers with a program that can be installed on the user terminals which contains the necessary software for providing beauty guidance. In an alternative implementation, the user terminals may download software from the central computer and may intermittently receive updated versions of the program from the central computer. Moreover, in other embodiments, software and/or firmware of the present invention may be distributed and shared among a central computer and user terminals.

The present invention has been described in relation to a particular example which is intended in all respects to be illustrative rather than restrictive. Those skilled in the art will appreciate that many different combinations of hardware, software, and/or firmware will be suitable for practicing the present invention.

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

Cross-reference to Concurrently Filed Applications and Global Definitions

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 60/325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Historical Beauty Record, Attorney Docket No. 05725.0975; Identification And Presentation Of Analogous Beauty Case Histories, Attorney Docket No. 05725.0976; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Beauty Advisory System And Method, Attorney Docket No. 05725.0980; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0985; Cosmetic Affinity Indexing, Attorney Docket No. 05725.0986; Systems And Methods For Providing Beauty Guidance, Attorney Docket No. 05725.0987; Methods And Systems Involving Simulated Application Of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc, are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products-scrubs, rinses, washes, moisturizers, wrinkle removers, exfoliates, toners, cleansers, conditioners, shampoos, cuticle creams, oils, and anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An AI engine may be any system configured to apply knowledge and that can adapt itself and learn to do better in changing environments. Thus, the AI engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the AI engine may learn to adapt to unknown or changing environment for better performance. AI engines may be implemented or provided with a wide variety of components or systems, including one or more of the following: central processing units, co-processors, memories, registers, or other data processing devices and subsystems.

AI engines may be trained based on input such as product information, expert advice, user profile, or data based on sensory perceptions. Using input an AI engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, AI engine may learn to modify its behavior in response to its environment, and obtain knowledge. Knowledge may represent any information upon which Al engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the AI engine or any other component of the system.

“Personal information”, “subject specific information”, “user specific information”, “user profile”, “personal characteristics”, “personal attributes”, “profile information”, and like terms (collectively referred to in this section as “personal information”) may broadly encompass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding clientside methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. An electronic beauty analysis method, comprising:
maintaining beauty information in a data structure;
receiving personal information about a subject;
selecting for presentation to the subject at least some beauty information maintained in the data structure based on the received information;
presenting to the subject an image of a virtual beauty consultant; and
causing the image of the consultant to present to the subject the beauty information selected for presentation.

2. The method of claim 1, wherein beauty information includes queries.

3. The method of claims 1 or 2, wherein beauty information includes at least one of a product recommendation, a diagnostic recommendation, a cosmetic usage recommendation, a prediction, a beauty profile, a preventative measure, and a remedial measure.

4. The method of claim 2, further comprising recording answers to the queries and asking the user additional queries incorporating into the additional queries information reflective of recorded answers.

5. The method of claims 2, further comprising recording answers to the queries, and wherein causing the image of the consultant to appear as audibly presenting to the subject the beauty information includes causing the image to appear as providing at least one of a product recommendation, a diagnostic recommendation, a cosmetic usage recommendation, a prediction, a beauty profile, a preventative measure, or a remedial measure based on the recorded answers to the queries.

6. The method of claim 1, wherein maintaining beauty information involves storing the information on a storage device.

7. The method of claim 1, wherein maintaining beauty information involves providing access to a remote location where the information is maintained.

8. The method of claim 1, wherein the beauty information is stored in a data structure connected to the Internet, and wherein the method further comprises providing the subject with access to the data structure over the Internet.

9. The method of claim 2, wherein receiving personal information includes recording answers to the queries.

10. The method of claim 1, wherein receiving personal information includes obtaining the information from the subject via an audio capture device.

11. The method of claim 1, wherein receiving personal information includes obtaining the information from the subject via a user interface.

12. The method of claim 1, wherein receiving personal information includes obtaining the information from the subject via a network.

13. The method of claim 1, wherein presenting to the subject an image of a virtual beauty consultant involves causing the image to be displayed on a display device.

14. The method of claim 1, wherein presenting to the subject an image of a virtual beauty consultant involves causing a synthesized image to be displayed to the subject.

15. The method of claim 1, wherein presenting to the subject an image of a virtual beauty consultant involves causing a pre-recorded image of an actual human being to be displayed to the subject.

16. The method of claim 1, wherein presenting to the subject an image of a virtual beauty consultant involves allowing the subject to choose an image to be presented.

17. The method of claim 1, wherein presenting to the an image of a virtual beauty consultant involves selecting, from a group of virtual beauty consultants, a consultant that matches characteristics of the subject.

18. The method of claim 1, wherein presenting to the subject includes causing a synthesized human voice to be audibly projected through an audio output device.

19. The method of claim 1, wherein presenting includes causing a pre-recorded human voice to be audibly projected to the user.

20. The method of claim 1, further comprising presenting to the subject an image of a virtual user receiving the beauty information.

21. The method of claim 20, wherein the image of the virtual user is a representation of the subject.

22. An electronic beauty guidance method, comprising:
storing a series of beauty related queries in a data structure;
establishing an interface with a subject for enabling the subject to participate in an interactive beauty analysis;
presenting to the subject a human image via a display device accessed by the subject; and
causing the human image to appear as audibly presenting to the subject at least one of the queries from the data structure, to thereby conduct the interactive beauty analysis with the subject.

23. The method of claim 22, wherein the queries are stored at a location remote from the subject, and wherein the subject is enabled to participate in the beauty analysis from a location of the subject's choosing through access to the data structure via a network.

24. The method of claim 22, wherein audibly presenting includes causing a synthesized human voice to be audibly projected through the interface.

25. The method of claim 22, wherein audibly presenting includes causing a pre-recorded human voice to be audibly projected through the interface.

26. The method of claim 22, wherein the human image is a pre-recorded image of an actual human being.

27. The method of claim 22, wherein the human image is synthesized.

28. The method of claim 22, further comprising causing the subject to be asked personal questions, recording answers to the personal questions, and asking the subject additional questions incorporating into the additional questions information reflective of recorded answers to the personal questions.

29. The method of claim 23, wherein the queries are stored in a data structure connected to the Internet, and wherein the subject accesses the data structure over the Internet.

30. The method of claim 22 further comprising identifying to the subject at least one beauty test, storing in the data structure directions on how to conduct the beauty test, and causing the human image to appear as audibly presenting to the subject the directions from the data structure for conducting the at least one test.

31. The method of claim 22, further comprising presenting to the subject an image of a virtual user receiving the beauty information.

32. The method of claim 31, wherein the image of the virtual user is a representation of the subject.

33. An electronic beauty consulting system, the system comprising:
a data structure for storing a series of beauty queries;
a user terminal for enabling a subject to seek beauty advice, the terminal being linked to the data structure; and
a module configured to cause a human image to appear to the subject through the terminal in a manner projecting an appearance that the human image asks at least one query from the data structure to the subject.

34. The system of claim 33, wherein the user terminal is remotely located with respect to the data structure.

35. The system of claim 33, wherein the module causes a synthesized human voice to be audibly projected through the terminal.

36. The system of claim 33, wherein the module causes a pre-recorded human voice to be audibly projected through the terminal.

37. The system of claim 33, wherein the module causes a pre-recorded human image to be visually projected through the terminal.

38. The system of claim 33, wherein the module causes a synthesized human image to be visually projected through the terminal.

39. The system of claim 33, wherein the data structure is a linked list.

40. The system of claim 33, wherein the data structure contains personal information queries.

41. The system of claim 40, wherein the personal information queries are presented to the subject through the terminal, responses are recorded, and information reflective of the recorded responses is incorporated into subsequent beauty queries.

42. The method of claim 33, wherein the module is also configured to cause a second human image to appear to the subject through the terminal in a manner projecting an appearance that the second human image answers the at least one query.

43. The method of claim 42, wherein the second human image is a representation of the subject.
